(19) United States
(12) Patent Application Publication
(10) Pub. No.: US 2026/0267607 A1
(43) Pub. Date: Sep. 10, 2026

(54) ANALOG SIGNAL MULTIPLIER

(71) Applicant: BAE Systems Information and Electronic Systems Integration Inc., Nashua, NH (US)

(72) Inventor: Daniel P. Lacroix, Westford, MA (US)

(73) Assignee: BAE Systems Information and Electronic Systems Integration Inc., Nashua, NH (US)

(21) Appl. No.: 19/070,060

(22) Filed: Mar. 4, 2025

(51) Int. Cl. G06F 7/523; G06F 7/50

(52) U.S. Cl. CPC G06F 7/523; G06F 7/50

(57) ABSTRACT

A signal multiplier includes a sum circuit configured to receive a plurality of input signals and to produce a sum of the input signals; a difference circuit configured to receive the input signals and to produce a difference between the input signals; and a signal squaring circuit configured to receive the sum of the input signals and the difference between the input signals, and to produce a square of the sum of the input signals and a square of the difference of the input signals. The sum circuit, the difference circuit, or both are configured to operate in a passive charge domain.

### STATEMENT OF GOVERNMENT INTEREST

This invention was made with government support under contract FA8650-23-C-7304 with the Department of Defense. The government has certain rights in the invention.

### FIELD OF DISCLOSURE

The present disclosure relates to signal processing techniques, and more particularly, to techniques for analog signal multiplication.

### BACKGROUND

A signal multiplier is an electronic device that produces an output signal, which is the product of two input signals. When the input signals are analog, the output signal varies linearly with respect to the inputs. A four-quadrant multiplier generates products of complex signals having both positive and negative polarities. However, noise and offset voltages in the signals are similarly multiplied, which makes such devices particularly prone to significant error. In addition, high speed operation can require significant power. Therefore, non-trivial issues remain with respect to analog signal multipliers.

### BRIEF DESCRIPTION OF THE DRAWINGS

FIG. 1 is a block diagram of a signal multiplier, in accordance with an example of the present disclosure.

FIG. 2 is a schematic diagram of a single-ended signal sum circuit that can be implemented in the signal multiplier of FIG. 1, in accordance with an example of the present disclosure.

FIG. 3 is a schematic diagram of a differential signal sum circuit that can be implemented in the signal multiplier of FIG. 1, in accordance with an example of the present disclosure.

FIG. 4 is a schematic diagram of a differential signal difference circuit that can be implemented in the signal multiplier of FIG. 1, in accordance with an example of the present disclosure.

FIG. 5 is a block diagram of a signal squaring circuit that can be implemented in the signal multiplier of FIG. 1, in accordance with an example of the present disclosure.

FIG. 6 is a schematic diagram of the differential pairs of FIG. 5, in accordance with an example of the present disclosure.

FIG. 7A is a block diagram of a complex signal multiplier, in accordance with an example of the present disclosure.

FIG. 7B is a schematic diagram of two multiplier circuits that can be implemented in the complex signal multiplier of FIG. 7A, in accordance with an example of the present disclosure.

FIG. 7C is a schematic diagram of an implementation of a summing function that can be implemented in the complex signal multiplier of FIG. 7A, in accordance with an example of the present disclosure.

FIGS. 7D and 7E are schematic diagrams of portions of the complex signal multiplier of FIG. 7A configured to produce single differential product outputs, in accordance with examples of the present disclosure.

FIG. 8A is a block diagram of a complex multiplier difference of products circuit and a complex multiplier sum of products circuit, in accordance with an example of the present disclosure.

FIG. 8B is a schematic diagram of the complex multiplier difference of products circuit of FIG. 8A, in accordance with an example of the present disclosure.

FIG. 9A is a block diagram of a complex multiplier difference of products circuit and a complex multiplier sum of products circuit, in accordance with an example of the present disclosure.

FIG. 9B is a schematic diagram of the complex multiplier sum of products circuit of FIG. 9A, in accordance with an example of the present disclosure.

FIG. 10 is a schematic diagram of an input offset correction circuit that can be used in conjunction with the signal multiplier of FIG. 1 and/or the complex signal multiplier of FIG. 7A, in accordance with an example of the present disclosure.

Although the following detailed description refers to illustrative examples, many alternatives, modifications, and variations thereof will be apparent in light of this disclosure.

### DETAILED DESCRIPTION

Techniques are provided herein for analog signal multiplication, and more particularly for complex signal multiplication. In accordance with an example of the present disclosure, a signal multiplier includes: a sum circuit configured to receive a plurality of input signals and to produce a sum of the input signals; a difference circuit configured to receive the input signals and to produce a difference between the input signals; and a signal squaring circuit configured to receive the sum of the input signals and the difference between the input signals, and to produce a square of the sum of the input signals and a square of the difference of the input signals. The sum circuit, the difference circuit, or both are configured to operate in a passive charge domain, as opposed to other circuits (e.g., active analog signal amplifiers) that operate in the voltage and current domains.

For example, the sum circuit and/or the difference circuit include a first capacitor and a second capacitor in parallel with the first capacitor, where the first capacitor is configured to receive a first one of the input signals via a first switch, the second capacitor is configured to receive a second one of the input signals via a second switch, the first capacitor is operatively coupled to an output via a third switch, and the second capacitor is operatively coupled to the output. The first switch and the second switch are closed by a first control pulse, and the third switch is closed by a second control pulse, where the second control pulse occurs subsequent to the first control pulse. Such passive charge domain circuits can reduce current dissipation (e.g., by about two-thirds) compared to active analog signal amplifiers.

Previous approaches have used active analog circuitry to provide summing and differencing functions. Examples of the present disclose use a charge domain sampled signal approach, which provides very low power and high speed operation. In addition, a novel approach is used to implement signal summing and differencing functions within the complex multiplier, which uses a low transistor count and correspondingly low current dissipation. An input offset calibration approach is implemented to minimize these issues.

The techniques described herein can be used to provide a high linearity, high speed, extremely low power analog circuit capable of multiplying two complex (real and imaginary) valued signals using complex multiplication. Some examples include a hybrid charge domain/continuous time analog circuit for complex signal multiplication. Some examples further incorporate a calibration technique to compensate for process induced mismatches of semiconductor devices on the input side of the multiplier.

As noted above, a four-quadrant multiplier is one in which the signals have both positive and negative polarities. The output of the multiplier can be represented as the difference between the squares of the sum and difference of the input signals, respectively:

$${V}_{o} = {( {V}_{1} + {V}_{2} )}^{2} - {( {V}_{1} - {V}_{2} )}^{2} = 4 {V}_{1} {V}_{2} \qquad ( 1 )$$

In an example, the sum and difference are each produced using discrete circuitry, and the signal squaring is produced using differential input voltage squaring circuitry (e.g., based on a differential pair circuit that amplifies the voltage difference between inputs) at the outputs of the sum circuitry and the difference circuitry, respectively. The differential pair includes metal oxide semiconductor field effect transistors (MOSFET) operating in the saturation region (that is, above threshold) where the transistor exhibits square law behavior. The sum and difference circuitry is implemented using passive charge domain circuits, which reduces current dissipation in comparison to existing techniques that use fully active differential pairs within the sum and difference circuitry. In some examples, the sum and difference circuitry includes differential amplifiers that are present in the signal squaring circuit, which further reduces power consumption.

In contrast to active analog signal amplifiers that operate in the voltage and current domains, passive charge domain processing uses switched capacitive circuits to manipulate the control of the signals for performing arithmetic operations in the multiplier. As used herein, a passive charge domain includes, in addition to its plain and ordinary meaning, an electrical circuit that operates in a domain where the circuit consumes energy but does not produce energy. As used herein, a passive charge, in addition to its plain and ordinary meaning, is a charge that is stored or present in a capacitive device without any active control of the capacitive device. For example, a passive charge domain adder and a passive charge domain subtractor can be controlled to provide the sum and difference between two input signals by switching the signals into and out of a pair of parallel capacitors for single-ended addition and subtraction, or into and out of two parallel pairs of parallel capacitors for differential signal addition and subtraction (one pair for each polarity of the input signals). This approach can be extended to complex signals in the real and imaginary domains using adders and subtractors for each combination of real and imaginary signal components (e.g., the sums and differences of each of (X_{REAL}, Y_{REAL}), (X_{REAL}, Y_{IMAG}), (X_{IMAG}, Y_{REAL}), and (X_{IMAG}, Y_{IMAG})).

Offset variations of the input signal caused by process-induced device mismatch (e.g., mismatches between the input pairs of the signal squaring circuits) can degrade the linearity performance of the multiplier. Such input offset variations can be corrected in the differential pair squaring circuit by adding circuitry to sample, for instance, the gate to source voltage (VGS) of each MOSFET while the transistor is biased at a constant, common current bias. Other suitable transistor technology may be used.

### Example Signal Multiplier

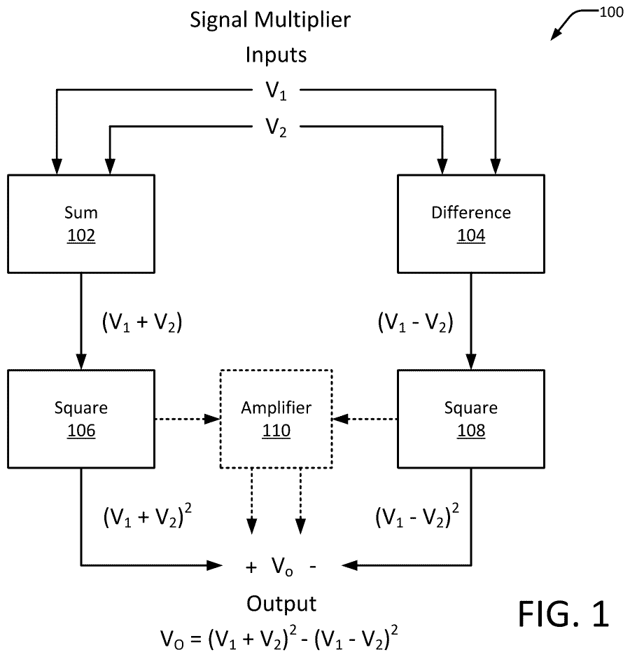

FIG. 1 is a block diagram of a signal multiplier 100, in accordance with an example of the present disclosure. The signal multiplier 100 has a sum circuit 102, a difference circuit 104, and signal squaring circuits 106 and 108. The sum circuit 102 is configured to receive, as inputs, two input signals V₁ and V₂, and to produce, as outputs, a sum of the input signals (V₁+V₂). The difference circuit 104 is configured to receive, as inputs, the input signals V₁ and V₂, and to produce, as outputs, a difference between the input signals (V₁−V₂). The signal squaring circuit 106 is configured to receive, as an input, the sum of the input signals (V₁+V₂), and to produce, as an output, a square of the sum of the input signals (V₁+V₂)². The signal squaring circuit 108 is configured to receive, as an input, the difference between the input signals (V₁−V₂), and to produce, as an output, a square of the difference of the input signals (V₁−V₂)². The output of the signal multiplier 100 is a signal V₀ based on the square of the sum of the input signals and the square of the difference of the input signals (V₁+V₂)²−(V₁−V₂)²=4V₁V₂.

In some examples, the signal multiplier 100 further includes an amplifier circuit 110 configured to amplify or buffer the output signal V₀.

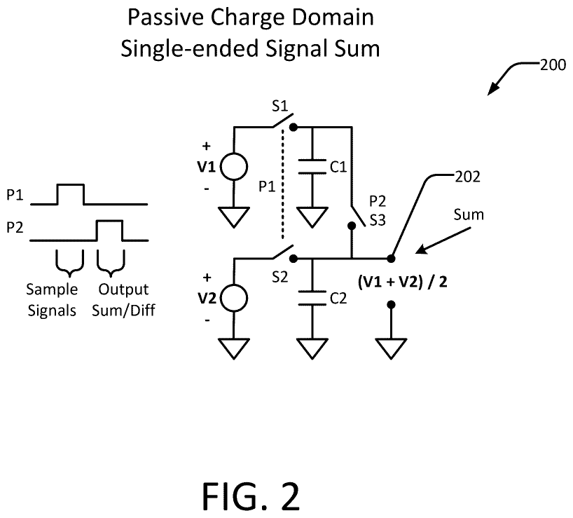

As will be described in further detail with respect to FIGS. 2, 3, and 4, in some examples the sum circuit 102, the difference circuit 104, or both circuits can be implemented as circuits operating in the passive charge domain rather than, or in addition to, circuits operating in the continuous time (analog) domain.

### Passive Charge Domain Signal Sum and Difference—Single Ended

FIG. 2 is a schematic diagram of a single-ended signal sum circuit 200 that can be implemented in the signal multiplier 100 of FIG. 1, in accordance with an example of the present disclosure. The sum circuit 102 and/or the difference circuit 104 can, in some examples, be implemented in at least a portion of the single-ended signal sum circuit 200. The single-ended signal sum circuit 200 operates in the passive charge domain as follows. The single-ended signal sum circuit 200 includes two capacitors C1 and C2 in parallel with each other. The capacitor C1 is configured to receive the input signal V₁ via a first switch S1 and the capacitor C2 is configured to receive the input signal V₂ via a second switch S2. The capacitor C1 is operatively coupled to an output 202, which is the sum of the input signals V₁ and V₂, via a third switch S3. The capacitor C2 is operatively coupled to the output. The circuit 200 is considered single-ended because it is only coupled to one polarity of the input signals V₁ and V₂ (e.g., where both input signals V₁ and V₂ are positive or negative, the circuit 200 produces a sum of the input signals, and where the polarities of the input signals V₁ and V₂ are opposite, the circuit 200 produces a difference of the input signals).

Switches S1 and S2 are closed by control pulse P1, which couples the capacitors C1 and C2 to the input signals V₁ and V₂ for a period of time. Switch S3 is closed by control pulse P2, which occurs subsequent to the control pulse P1, thereby coupling C1 and C2 to the output 202. The switches S1 and S2 are open while the switch S3 is closed, and the switch S3 is open while the switches S1 and S2 are closed. The output 202 in this example is one half of the sum of the input signals V₁ and V₂ by virtue of the parallel coupling of the capacitors C1 and C2 and the polarities of the input signals V₁ and V₂.

In another example, S3 can be implemented as two switches, (e.g., S3 and S4, not shown), where S3 connects C1 to the output and S4 switches C2 to the output. S3 and S4 are controlled by the same P2 signal. This approach isolates the output from the V2 input signal at all times.

### Passive Charge Domain Signal Sum and Difference—Differential

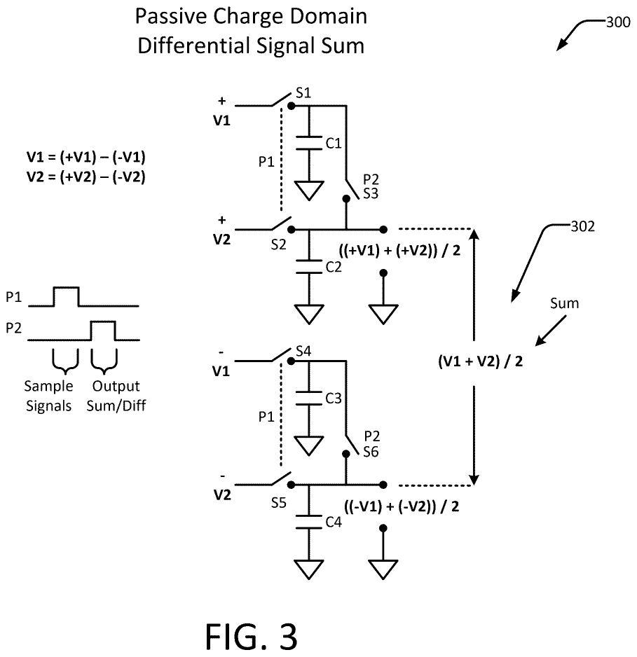

FIG. 3 is a schematic diagram of a differential signal sum circuit 300 that can be implemented in the signal multiplier 100 of FIG. 1, in accordance with an example of the present disclosure. The sum circuit 102 can, in some examples, be implemented in at least a portion of the differential signal sum circuit 300. The differential signal sum circuit 300 operates in the passive charge domain as follows. The differential signal sum circuit 300 includes four capacitors C1, C2, C3, and C4 in parallel with each other. The capacitor C1 is configured to receive the positive input signal V₁ via a first switch S1 and the capacitor C2 is configured to receive the positive input signal V₂ via a second switch S2. The capacitor C1 is operatively coupled to an output 302, which is the sum of the positive input signals V₁ and V₂, via a third switch S3. The capacitor C2 is operatively coupled to the output 302. The capacitor C3 is configured to receive the negative input signal V₁ via a fourth switch S4 and the capacitor C4 is configured to receive the negative input signal V₂ via a fifth switch S5. The capacitor C4 is operatively coupled to the output 302, which is the sum of the negative input signals V₁ and V₂, via a sixth switch S6. The capacitor C4 is operatively coupled to the output 302. The circuit 300 is considered differential because it is separately coupled to each polarity of the input signals V₁ and V₂.

Switches S1, S2, S4, and S5 are closed by control pulse P1, which couples the capacitors C1 and C2 to the positive input signals V₁ and V₂ and capacitors C3 and C4 to the negative input signals V₁ and V₂ for a period of time. Switches S3 and S6 are closed by control pulse P2, which occurs subsequent to the control pulse P1, thereby coupling C1, C2, C3, and C4 to the output 302. The output 302 in this example is one half of the sum of the input signals V₁ and V₂ by virtue of the parallel coupling of the capacitors C1, C2, C3, and C4 and the polarities of the input signals V₁ and V₂.

In another example, S3 can be implemented as two switches, (e.g., S3 and S4), where S3 connects C1 to the output and S4 switches C2 to the output. S3 and S4 are controlled by the same P2 signal. This approach isolates the output from the V2 input signal at all times.

In another example, S3 can be implemented as two switches, (e.g., S3 and S4, not shown), where S3 connects C1 to the output and S4 switches C2 to the output. S3 and S4 are controlled by the same P2 signal. This approach isolates the output from the V2 input signal at all times.

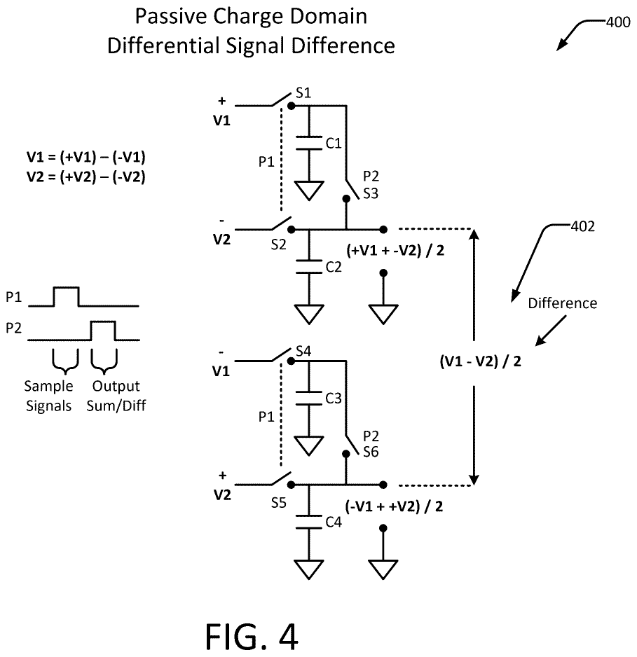

FIG. 4 is a schematic diagram of a differential signal difference circuit 400 that can be implemented in the signal multiplier 100 of FIG. 1, in accordance with an example of the present disclosure. The difference circuit 104 can, in some examples, be implemented in at least a portion of the differential signal difference circuit 400. The differential signal difference circuit 400 operates similarly to the differential sum circuit 300 of FIG. 3 except the polarities of the input signals are opposed, as shown. The differential signal difference circuit 400 includes four capacitors C1, C2, C3, and C4 in parallel with each other. The capacitor C1 is configured to receive the positive input signal V₁ via a first switch S1 and the capacitor C2 configured to receive the negative input signal V₂ via a second switch S2. The capacitor C1 is operatively coupled to an output 402, which is the difference of the input signals V₁ and V₂, via a third switch S3. The capacitor C2 is operatively coupled to the output 402. The capacitor C3 is configured to receive the negative input signal V₁ via a fourth switch S4 and the capacitor C4 is configured to receive the positive input signal V₂ via a fifth switch S5. The capacitor C4 is operatively coupled to the output 402, which is the difference of the input signals V₁ and V₂, via a sixth switch S6. The capacitor C4 is operatively coupled to the output 402. The circuit 400 is considered differential because it is separately coupled to each polarity of the input signals V₁ and V₂.

Switches S1, S2, S4, and S5 are closed by control pulse P1, which couples the capacitors C1 and C2 to the input signals V₁ and V₂ and capacitors C3 and C4 to the input signals V₁ and V₂ for a period of time. Switches S3 and S6 are closed by control pulse P2, which occurs subsequent to the control pulse P1, thereby coupling C1, C2, C3, and C4 to the output 402. The output 402 in this example is one half of the difference of the input signals V₁ and V₂ by virtue of the parallel coupling of the capacitors C1, C2, C3, and C4 and the polarities of the input signals V₁ and V₂.

In another example, S3 can be implemented as two switches, (e.g., S3 and S4, not shown), where S3 connects C1 to the output and S4 switches C2 to the output. S3 and S4 are controlled by the same P2 signal. This approach isolates the output from the V2 input signal at all times.

### Signal Squaring

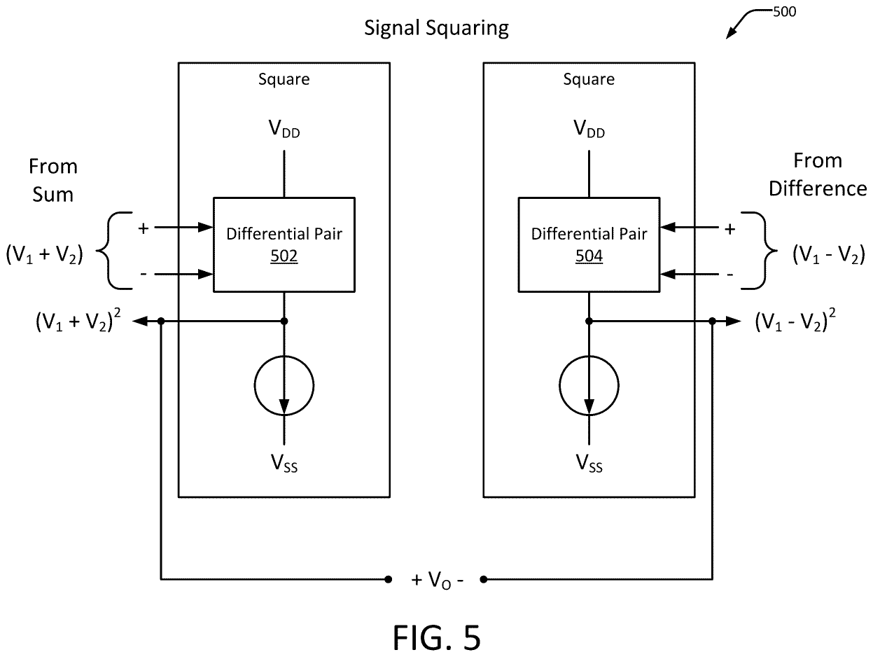

FIG. 5 is a block diagram of a signal squaring circuit 500 that can be implemented in the signal multiplier 100 of FIG. 1, in accordance with an example of the present disclosure. The signal squaring circuit 500 can be implemented, for example, in the signal squaring circuits 106 and 108 of FIG. 1. The inputs to the signal squaring circuit 500 are the outputs of the sum circuit 102 and the difference circuit 104; that is, the sum of the input voltages V₁ and V₂ and the difference of the input voltages V₁ and V₂. The output of the signal squaring circuit 500 is the signal V₀ based on the square of the sum of the input signals and the square of the difference of the input signals (V₁+V₂)²−(V₁−V₂)²=4V₁V₂.

In this example, the signal squaring circuit 500 includes two differential pairs 502 and 504. The differential pair 502 receives, as inputs, the sum of the input signals V₁ and V₂ and produces, as an output, the square of the sum (V₁+V₂)². The differential pair 504 receives, as inputs, the difference of the input signals V₁ and V₂ and produces, as an output, the square of the difference (V₁+V₂)².

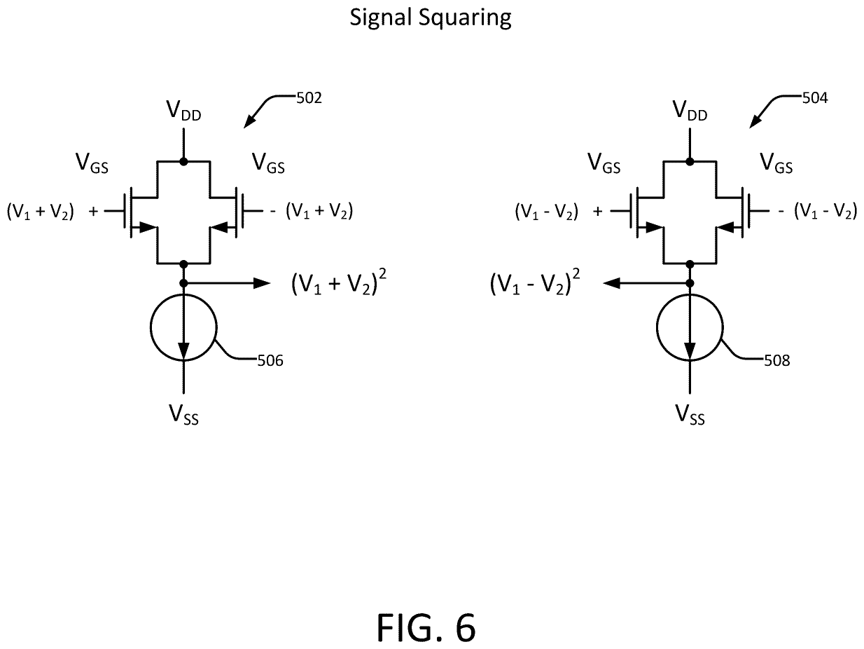

FIG. 6 is a schematic diagram of the differential pairs 502 and 504 of FIG. 5, in accordance with an example of the present disclosure. Each differential pair 502, 504 includes a MOSFET-type differential-amplifier operatively coupled to a positive voltage source V_{DD} node or terminal, and a negative voltage source Vₛₛ node or terminal. The transistors in each differential pair 502 and 504 are matched and operatively coupled in parallel to a current source 506, 508 that pulls current down through the transistors. The MOSFETs operate above threshold (strong inversion) in order to exhibit square law behavior.

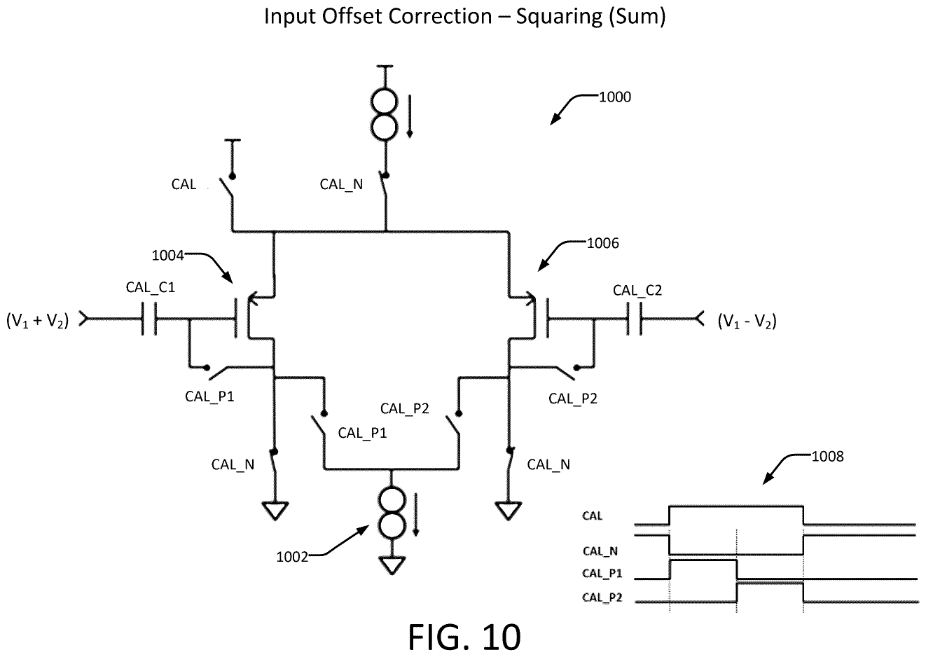

In some examples, variations in the matched transistors (e.g., due to manufacturing process variances, etc.) can degrade the linearity of the signal multiplier 100. Such input offset variations can be corrected using correction circuitry to sample the gate-source voltage of each transistor while biased with a constant, common current, such as described in further detail below with respect to FIG. 10.

### Complex Signal Multiplier

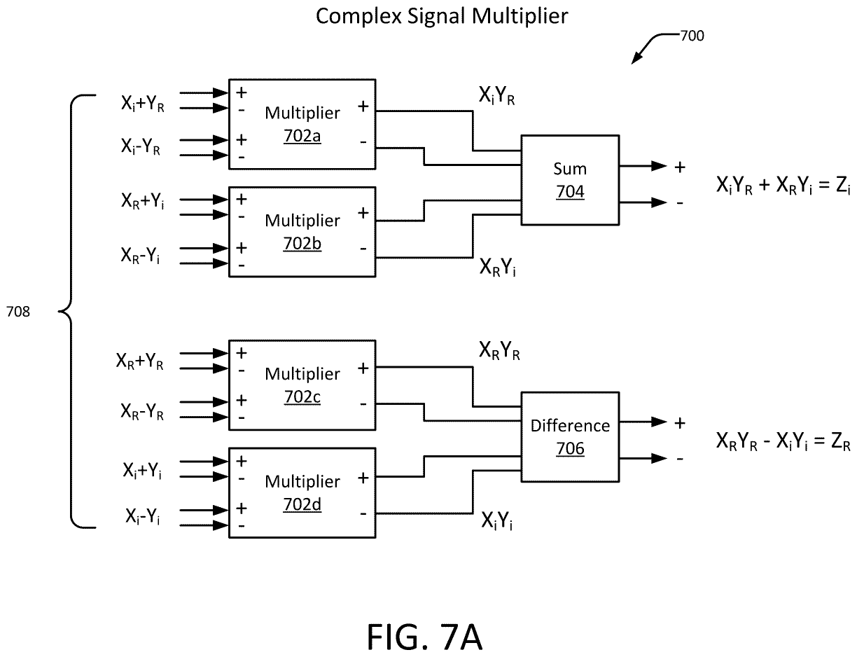

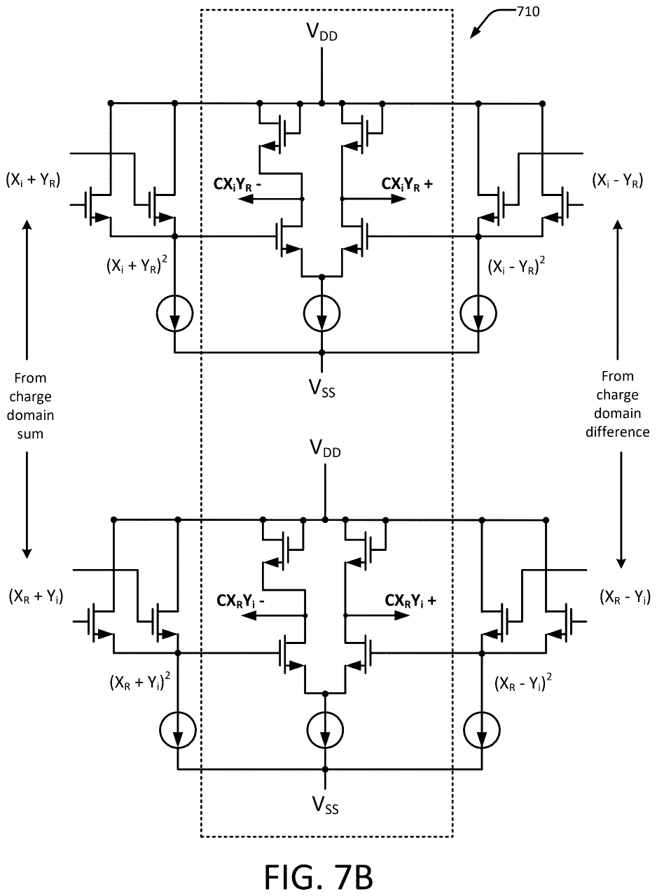

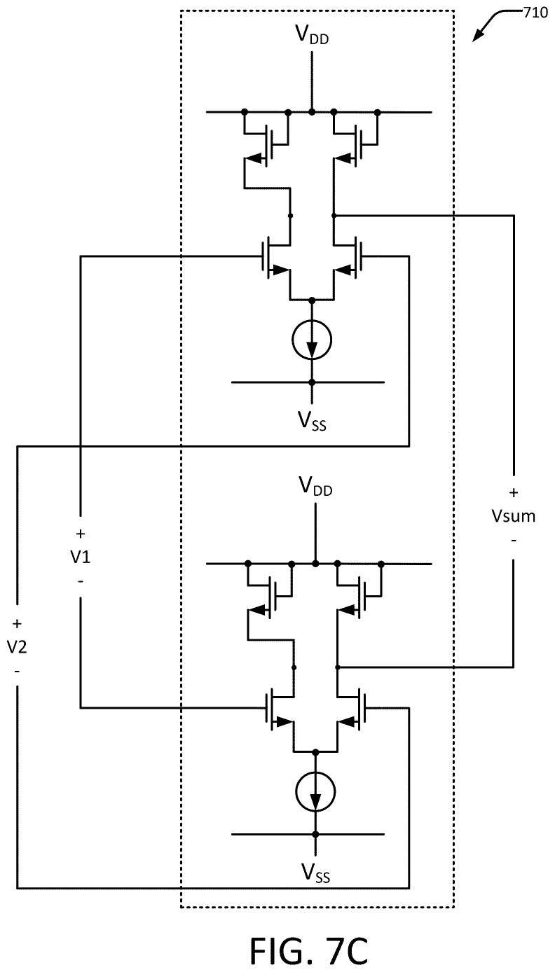

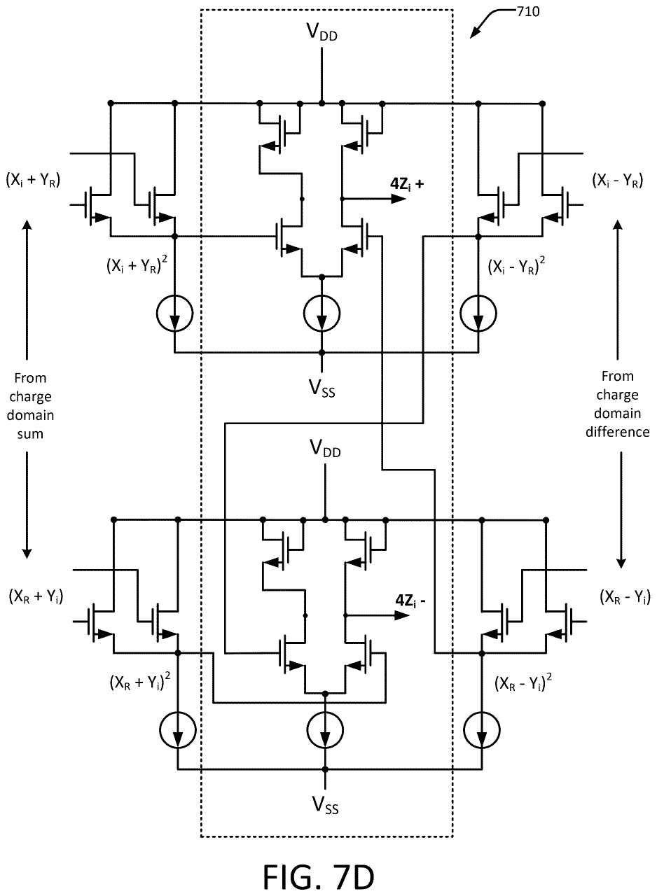

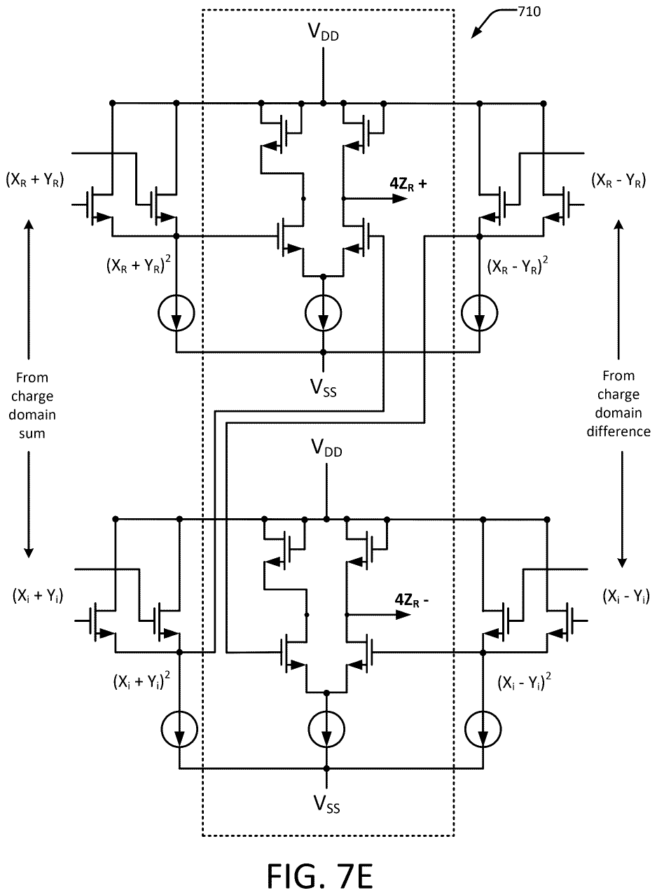

FIG. 7A is a block diagram of a complex signal multiplier 700, in accordance with an example of the present disclosure. The complex signal multiplier 700 operates on similar principles as the signal multiplier 100 of FIG. 1 to multiply signals with both real and imaginary components. For example, two signals X and Y can have real components X_{R} and Y_{R}, and imaginary components Xᵢ and Yᵢ. Multiplication of X and Y produces a complex signal Z, with a real component Z_{R} and an imaginary component Zᵢ, as follows:

$$( {X}_{R} + j {X}_{i} ) \cdot ( {Y}_{R} + {jY}_{i} ) = {Z}_{R} + {Z}_{i} \qquad ( 2 )$$

where X_{R}, Y_{R}, Xᵢ, and Yᵢ represent analog differential input values. The resultant real and imaginary values are:

$${Z}_{R} = ( {X}_{R} {Y}_{R} - {X}_{i} {Y}_{i} ) \qquad ( 3 )$$

$${Z}_{i} = j ( {X}_{i} {Y}_{R} - {X}_{R} {Y}_{i} ) \qquad ( 4 )$$

These values include four multiplier circuits 702a, 702b, 702c, and 702d, a multiplier differential sum circuit 704, and a multiplier differential difference circuit 706, such as shown in FIG. 7A. The sum and difference signal inputs to the multiplier circuits 702a-d, generally indicated at 708, can be provided via charge domain processing, such as described with respect to FIGS. 2, 3, and 4. The products of the signal inputs 708 can be expressed as:

$${X}_{i} {Y}_{R} = \frac{( {( {X}_{i} + {Y}_{R} )}^{2} - {( {X}_{i} - {Y}_{R} )}^{2} )}{4} \qquad ( 5 )$$

$${X}_{R} {Y}_{i} = \frac{( {( {X}_{R} + {Y}_{i} )}^{2} - {( {X}_{R} - {Y}_{i} )}^{2} )}{4} \qquad ( 6 )$$

$${X}_{R} {Y}_{R} = \frac{( {( {X}_{R} + {Y}_{R} )}^{2} - {( {X}_{R} - {Y}_{R} )}^{2} )}{4} \qquad ( 7 )$$

$${X}_{i} {Y}_{i} = \frac{( {( {X}_{i} + {Y}_{i} )}^{2} - {( {X}_{i} - {Y}_{i} )}^{2} )}{4} \qquad ( 8 )$$

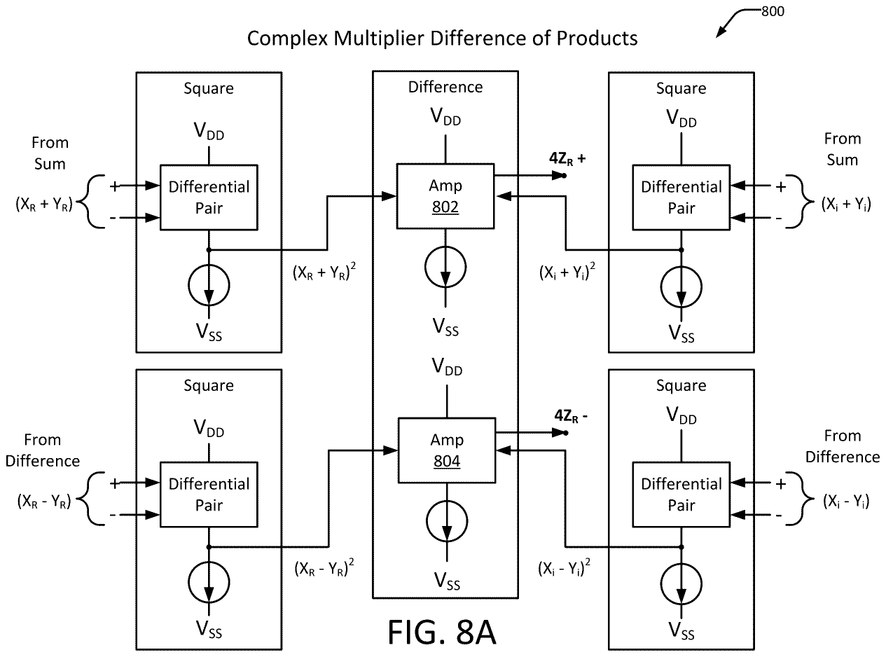

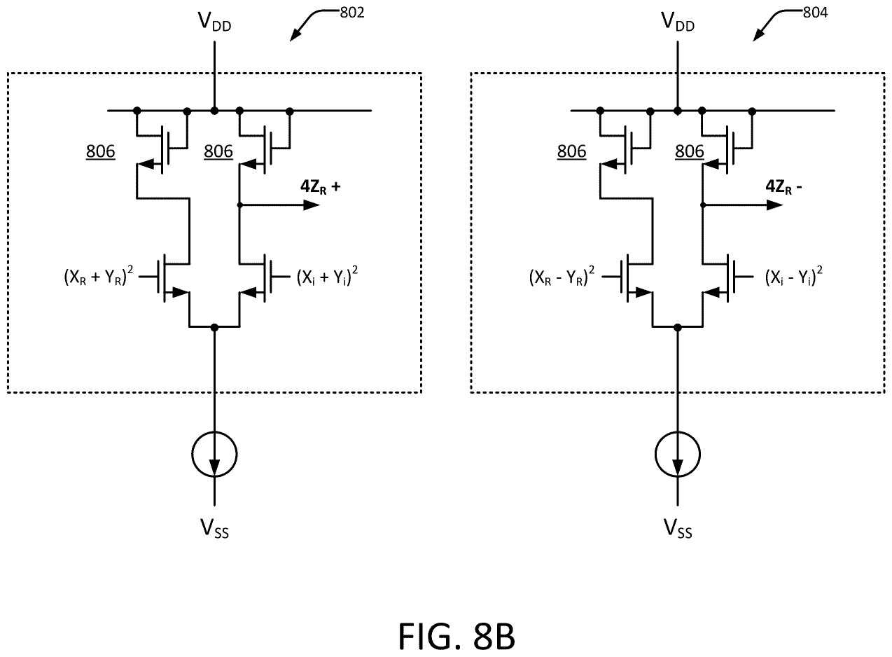

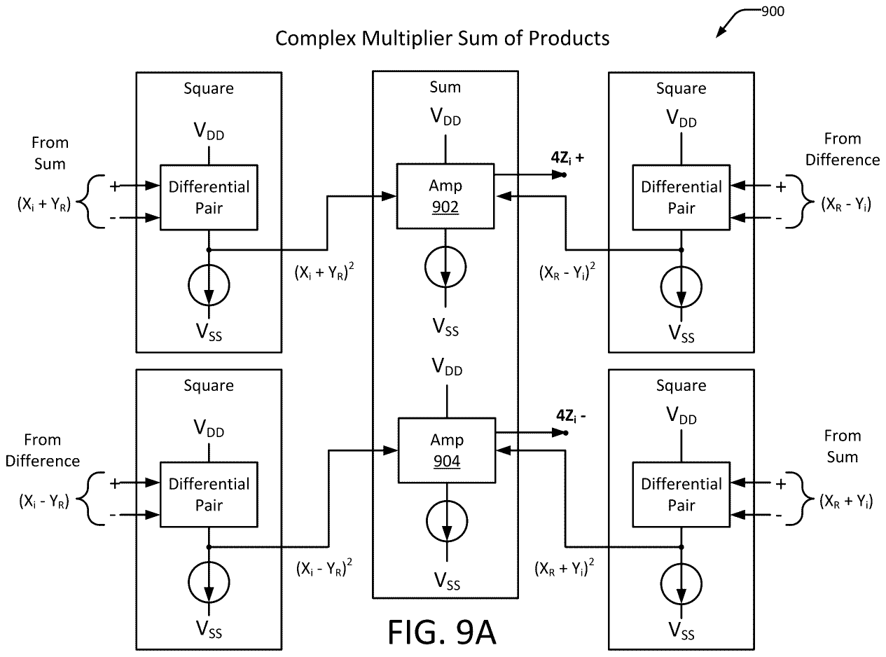

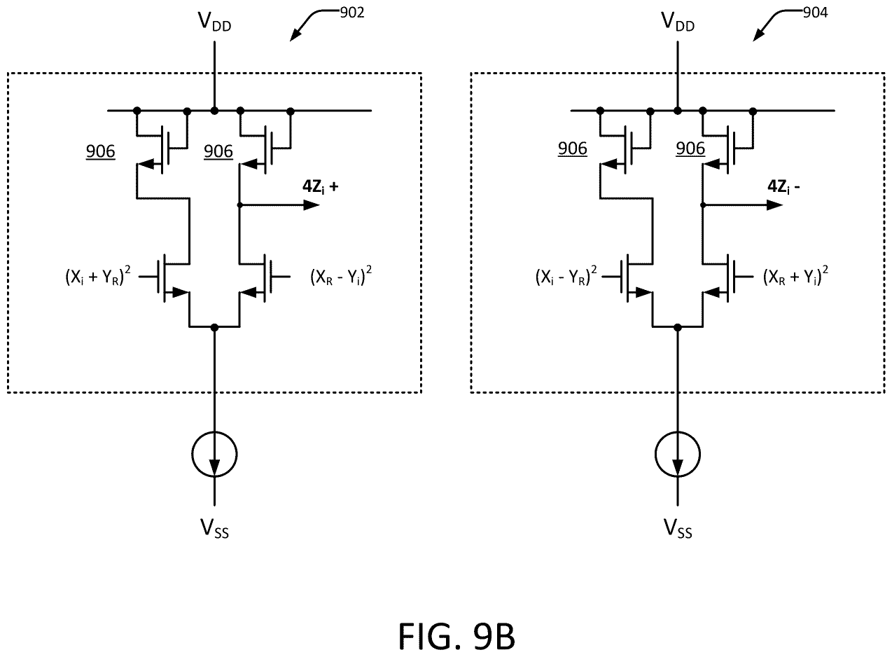

The multiplier differential sum circuit 704 and the multiplier differential difference circuit 706 produce the sum and difference, respectively, of the outputs of the multiplier circuits 702a-d, such as shown. The multiplier differential sum circuit 704 and the multiplier differential difference circuit 706 operate on two differential input pairs and can be implemented using differential amplifiers such as described with respect to FIGS. 8 and 9.

The configuration of the complex signal multiplier 700 can be derived, for example, from the signal multiplier 100 of FIG. 1, and the use of a property of differential amplifiers. FIG. 7B is a schematic diagram of two multiplier circuits 710 configured to generate the two product terms found in Equation 4, in accordance with an example of the present disclosure. The four differential sum and difference inputs (e.g., Xᵢ, X_{R}, Yᵢ, and Y_{R}) are squared, amplified, and buffered as differential output products, which are scaled by a constant factor, C, which is dependent on specifics of the MOSFET dimensions. The sum and difference functions 704 and 706 may thus require additional circuitry. However, the properties of differential amplifiers, such as shown in FIG. 7C, demonstrates an implementation of the summing function without the use of additional circuitry or power dissipation, where V1=(Xᵢ+Y_{R})²−(Xᵢ−Y_{R})² and V2=(X_{R}+Yᵢ)²−(X_{R}−Yᵢ)². The differential amplifiers shown in FIG. 7C provide an addition function; reversing the polarity of one input provides subtraction.

The multiplier differential difference circuit 706 is achieved by inverting the polarity of one differential input pairs in FIG. 7C. FIG. 7D shows the final realization of the Equation 4 with the output amplifiers modified to provide a single differential product output 4Zᵢ. FIG. 7E shows the final realization of the Equation 3 with the output amplifiers modified to provide a single differential product output 4Z_{R}.

FIGS. 8A and 9A are block diagrams of a complex multiplier difference of products circuit 800 and a complex multiplier sum of products circuit 900, and FIGS. 8B and 9B are schematic diagrams of the circuits 800 and 900, respectively, in accordance with examples of the present disclosure. The complex multiplier difference of products circuit 800 and the complex multiplier sum of products circuit 900 produce the Z_{R} and Zᵢ outputs, respectively, as defined above in Equations (3) and (4). In these examples, amplifiers 802 and 804 (e.g., differential to single-ended amplifiers) are used to compute a difference between the products of the complex signals X and Y, and amplifiers 902 and 904 are used to compute a sum of the products of the complex signals X and Y. The output of the complex multiplier difference of products circuit 800 is 4Z_{R} (+ and −), and the output of the complex multiplier sum of products 900 circuit is 4Zᵢ (+ and −). The differential pairs in amplifiers 802, 804, 902, and 904 can be similar to (or the same as) the differential pairs 502 and 504 of FIGS. 5 and 6 (e.g., MOSFET differential amplifiers). The common gate-to-drain connections of load transistors 806, 906 generates a square root I-V behavior that opposes the squaring function of the differential pair, thereby providing a linear input-output transfer function. A nominal function of the load transistors 806, 906 in a single multiplier implementation, such as the amplifier 110 of FIG. 1 is to provide a linear buffer stage to drive external loads. In this example, the same buffers can be used with alternate connections, such as shown, to additionally provide the sum/difference function for the complex multiplier 700 of FIG. 7A, such as shown in FIGS. 8A, 8B, 9A, and 9B.

### Input Offset Correction

As noted above, variations in the matched transistors (e.g., due to manufacturing process variances, etc.) of the differential pairs 502, 504 can degrade the linearity of the signal multiplier 100. Such input offset variations can be corrected using correction circuitry to sample the control terminal (e.g., gate) voltage of each transistor while biased with a constant, common current, such as described in further detail below with respect to FIG. 10.

FIG. 10 is a schematic diagrams of an input offset correction circuit 1000 that can be used in conjunction with the signal multiplier 100 of FIG. 1 and/or the complex signal multiplier 700 of FIG. 7A, in accordance with an example of the present disclosure. In overview, the input offset correction circuit 1000 corrects for input offset variations in the differential pairs 502, 504 of the signal squaring circuit 500 by sampling the gate-source voltage V_{GS} of each transistor at a constant, common current. In the example of FIG. 10, the input offset correction circuit 1000 is implemented as a sum circuit; however, it will be understood that a similar circuit can be implemented as a difference circuit by changing the signal inputs to (V₁−V₂).

The input offset correction circuit 1000 uses a single current source 1002. Calibration is performed sequentially for each input device via transistors 1004 and 1006, respectively. In doing so, any potential offset incurred by using two separate current sources is avoided. The inputs are tied to a fixed DC voltage (such as the input common mode voltage) during calibration to set a common reference for the sampled gate to source voltage.

The input offset correction circuit 1000 includes capacitors CAL_C1 and CAL_C2 operatively coupled to the control terminals (e.g., gates) of the transistors 1004, 1006. As shown in timing table 1008, during calibration mode, switch CAL is closed and switches CAL_N are open. During a first period of calibration, switch CAL_P1 is closed and switch CAL_P2 is open, drawing a calibration current through the transistor 1004 and placing a charge across capacitor CAL_C1, thereby sampling the control terminal (e.g., gate) voltage of transistor 1004. During a second period of calibration, switch CAL_P1 is open and switch CAL_P2 is closed, drawing a calibration current through the transistor 1006 and placing a charge across capacitor CAL_C2, thereby sampling the control terminal (e.g., gate) voltage of transistor 1006. At the end of calibration, switch CAL is opened and switch CAL_N is closed and switches CAL_P1 and CAL_P2 are open. In this manner, source voltage of the differential pair can, for example, be tied to a voltage lower than the supply voltage during calibration to ensure that the inputs remain in the appropriate common mode range.

### Further Examples

Various examples of the present disclosure can be implemented using hardware elements, software elements, or a combination of both. Examples of hardware elements can include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software can include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements can vary in accordance with any number of factors, such as desired computational rate, power level, heat tolerances, processing cycle budget, input data rates, output data rates, memory resources, data bus speeds, and other design or performance constraints.

Some embodiments can be described using the expression “coupled” and “connected” along with their derivatives. These terms are not intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

Some examples disclosed herein can be implemented in various forms of hardware, software, firmware, and/or special purpose processors. For example, in one example, at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one example, the system can be hosted on a given website and implemented, for example, using JavaScript or another suitable browser-based technology. The computer software applications disclosed herein can include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other examples are not limited to any particular hardware or software configuration.

The non-transitory computer readable medium can include any suitable medium for storing digital information, such as a hard drive, a server, a flash memory, and/or random-access memory (RAM), or a combination of memories. In some examples, the components and/or modules disclosed herein can be implemented with hardware, including gate level logic such as a field-programmable gate array (FPGA), or alternatively, a purpose-built semiconductor such as an application-specific integrated circuit (ASIC). Still other examples can be implemented with a microcontroller having a number of input/output ports for receiving and outputting data, and a number of embedded routines for carrying out the various functionalities disclosed herein. It will be apparent that any suitable combination of hardware, software, and firmware can be used, and that other examples are not limited to any particular system architecture.

Some examples can be implemented, for example, using a machine readable medium or article that stores a set of instructions that, when executed by a machine, causes the machine to perform a method, process, and/or operations in accordance with the examples described herein. Such a machine can include, for example, any suitable processing platform, computing platform, computing device, processing device, computing system, processing system, computer, process, or the like, and can be implemented using any suitable combination of hardware and/or software. The machine readable medium or article can include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions can include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it will be appreciated that terms such as “processing,” “computing,” “calculating,” and “determining” refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system.

The terms “circuit” or “circuitry” can include, for example, hardwired circuitry, programmable circuitry, such as computer processors comprising one or more individual instruction processing cores, state machine circuitry, and/or firmware that stores instructions executed by programmable circuitry. The circuitry can include a processor and/or controller configured to execute one or more instructions to perform one or more operations described herein. The instructions can be implemented as, for example, an application, software, firmware, etc., configured to cause the circuit or circuitry to perform any of the operations or functions described herein. Software can be implemented as a software package, code, instructions, instruction sets and/or data recorded on a computer-readable storage device. Software can be implemented to include any number of processes, and processes, in turn, can be implemented to include any number of threads, etc., in a hierarchical fashion. Firmware can be implemented as code, instructions or instruction sets and/or data that are hard-coded (e.g., nonvolatile) in memory devices. The circuit or circuitry can be implemented as part of a larger system, for example, an integrated circuit (IC), an application-specific integrated circuit (ASIC), a system-on-a-chip (SoC), desktop computers, laptop computers, tablet computers, servers, smartphones, etc. Other examples can be implemented as software executed by a programmable control device. In such cases, the terms “circuit” or “circuitry” are intended to include a combination of software and hardware such as a programmable control device or a processor capable of executing the software. As described herein, various examples can be implemented using hardware elements, software elements, or any combination thereof. Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, and/or chip sets.

The following examples pertain to further examples, from which numerous permutations and configurations will be apparent.

Example 1 provides a signal multiplier comprising a sum circuit configured to receive a plurality of input signals and to produce a sum of the input signals; a difference circuit configured to receive the input signals and to produce a difference between the input signals; and a signal squaring circuit configured to receive the sum of the input signals and the difference between the input signals, and to produce a square of the sum of the input signals and a square of the difference of the input signals; wherein one or both of the sum circuit and the difference circuit are configured to operate in a passive charge domain.

Example 2 includes the subject matter of Example 1, further comprising an amplifier circuit configured to amplify or buffer the square of the sum of the input signals and the square of the difference between the input signals.

Example 3 includes the subject matter of any one of Examples 1 and 2, wherein at least one of the sum circuit and the difference circuit includes a first capacitor and a second capacitor in parallel with the first capacitor, the first capacitor configured to receive a first one of the input signals via a first switch, the second capacitor configured to receive a second one of the input signals via a second switch, the first capacitor operatively coupled to an output via a third switch, and the second capacitor operatively coupled to the output.

Example 4 includes the subject matter of Example 3, wherein the first switch and the second switch are closed by a first control pulse, wherein the third switch is closed by a second control pulse, and wherein the second control pulse occurs subsequent to the first control pulse.

Example 5 includes the subject matter of any one of Examples 1-4, wherein the signal squaring circuit includes a first differential pair of transistors operatively coupled to a positive voltage source terminal, a negative voltage source terminal, and a terminal configured to provide the sum of the input signals, and a second differential pair of transistors operatively coupled to the positive voltage source terminal, the negative voltage source terminal, and a terminal configured to provide the difference between the input signals.

Example 6 includes the subject matter of Example 5, further comprising a capacitor operatively coupled to a control terminal of at least one of the transistors.

Example 7 includes the subject matter of any one of Examples 1-6, wherein the input signals are complex signals with real and imaginary components.

Example 7′ includes the subject matter of any one of Examples 1-7, wherein one or both of the sum circuit and the difference circuit are configured to operate in the passive charge domain where the sum circuit and/or the difference circuit consumes energy but does not produce energy.

Example 8 includes the subject matter of any one of Examples 7 or 7′, wherein the signal squaring circuit is a first signal squaring circuit configured to produce a first square of the sum of the input signals and a first square of the difference between the input signals, and wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the difference between the input signals.

Example 9 includes the subject matter of Example 8, wherein the multiplier sum circuit is further configured to produce a sum of the first square of the difference between the input signals and the second square of the sum of the input signals.

Example 10 includes the subject matter of any one of Examples 7-9 and 7′, wherein the signal squaring circuit is a first signal squaring circuit configured to produce a first square of the sum of the input signals and a first square of the difference between the input signals, and wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the sum of the input signals.

Example 11 includes the subject matter of Example 10, wherein the multiplier sum circuit is further configured to produce a sum of the first square of the difference between the input signals and the second square of the difference between the input signals.

Example 12 provides a signal multiplier comprising a passive charge domain sum circuit configured to receive a plurality of input signals and to produce a sum of the input signals, the passive charge domain sum circuit including a first capacitor and a second capacitor in parallel with the first capacitor, the first capacitor configured to receive a first one of the input signals via a first switch, the second capacitor configured to receive a second one of the input signals via a second switch, the first capacitor operatively coupled to an output via a third switch, and the second capacitor operatively coupled to the output; a passive charge domain difference circuit configured to receive the input signals and to produce a difference between the input signals, the passive charge domain difference circuit including a third capacitor and a fourth capacitor in parallel with the third capacitor, the third capacitor configured to receive the first one of the input signals via a fourth switch, the fourth capacitor configured to receive the second one of the input signals via a fifth switch, the third capacitor operatively coupled to an output via a sixth switch, and the second capacitor operatively coupled to the output; and a signal squaring circuit configured to receive the sum of the input signals and the difference between the input signals, and to produce a square of the sum of the input signals and a square of the difference of the input signals.

Example 13 includes the subject matter of Example 12, wherein the first switch, the second switch, the fourth switch, and the fifth switch are closed by a first control pulse, wherein the third switch and the sixth switch are closed by a second control pulse, and wherein the second control pulse occurs subsequent to the first control pulse.

Example 14 includes the subject matter of any one of Examples 12 and 13, wherein the signal squaring circuit includes a first differential pair of transistors operatively coupled to a positive voltage source terminal, a negative voltage source terminal, and a terminal configured to provide the sum of the input signals, and a second differential pair of transistors operatively coupled to the positive voltage source terminal, the negative voltage source terminal, and terminal configured to provide the difference between the input signals.

Example 15 includes the subject matter of Example 14, further comprising a capacitor operatively coupled to a control terminal of at least one of the transistors.

Example 16 includes the subject matter of any one of Examples 12-15, wherein the input signals are complex signals with real and imaginary components.

Example 17 provides a signal multiplier comprising a sum circuit configured to receive a plurality of input signals and to produce a sum of the input signals in a passive charge domain; a difference circuit configured to receive the input signals and to produce a difference between the input signals in a passive charge domain; and a signal squaring circuit configured to receive the sum of the input signals and the difference between the input signals, and to produce a square of the sum of the input signals and a square of the difference of the input signals.

Example 18 includes the subject matter of Example 17, wherein the input signals are complex signals with real and imaginary components, and wherein one or both of the sum circuit and the difference circuit are configured to operate in the passive charge domain where the sum circuit and/or the difference circuit consumes energy but does not produce energy.

Example 19 includes the subject matter of Example 18, wherein the signal squaring circuit is a first signal squaring circuit configured to produce a first square of the sum of the input signals and a first square of the difference between the input signals, wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the difference between the input signals, and wherein the multiplier sum circuit is further configured to produce a sum of the first square of the difference between the input signals and the second square of the sum of the input signals.

Example 20 includes the subject matter of any one of Examples 18 and 19, wherein the signal squaring circuit is a first signal squaring circuit configured to produce a first square of the sum of the input signals and a first square of the difference between the input signals, wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the sum of the input signals, and wherein the multiplier sum circuit is further configured to produce a sum of the first square of the difference between the input signals and the second square of the difference between the input signals.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A signal multiplier comprising:
a sum circuit configured to receive a plurality of input signals and to produce a sum of the input signals;
a difference circuit configured to receive the input signals and to produce a difference between the input signals; and
a signal squaring circuit configured to receive the sum of the input signals and the difference between the input signals, and to produce a square of the sum of the input signals and a square of the difference of the input signals,
wherein one or both of the sum circuit and the difference circuit are configured to operate in a passive charge domain.

2. The signal multiplier of claim 1, further comprising an amplifier circuit configured to amplify or buffer the square of the sum of the input signals and the square of the difference between the input signals.

3. The signal multiplier of claim 1, wherein at least one of the sum circuit and the difference circuit includes a first capacitor and a second capacitor in parallel with the first capacitor, the first capacitor configured to receive a first one of the input signals via a first switch, the second capacitor configured to receive a second one of the input signals via a second switch, the first capacitor operatively coupled to an output via a third switch, and the second capacitor operatively coupled to the output.

4. The signal multiplier of claim 3, wherein the first switch and the second switch are closed by a first control pulse, wherein the third switch is closed by a second control pulse, and wherein the second control pulse occurs subsequent to the first control pulse.

5. The signal multiplier of claim 1, wherein the signal squaring circuit includes a first differential pair of transistors operatively coupled to a positive voltage source terminal, a negative voltage source terminal, and a terminal configured to provide the sum of the input signals, and a second differential pair of transistors operatively coupled to the positive voltage source terminal, the negative voltage source terminal, and a terminal configured to provide the difference between the input signals.

6. The signal multiplier of claim 5, further comprising a capacitor operatively coupled to a control terminal of at least one of the transistors.

7. The signal multiplier of claim 1, wherein one or both of the sum circuit and the difference circuit are configured to operate in the passive charge domain where the sum circuit and/or the difference circuit consumes energy but does not produce energy.

8. The signal multiplier of claim 7, wherein the signal squaring circuit is a first signal squaring circuit configured to produce a first square of the sum of the input signals and a first square of the difference between the input signals, and wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the difference between the input signals.

9. The signal multiplier of claim 8, wherein the multiplier sum circuit is further configured to produce a sum of the first square of the difference between the input signals and the second square of the sum of the input signals.

10. The signal multiplier of claim 7, wherein the signal squaring circuit is a first signal squaring circuit configured to produce a first square of the sum of the input signals and a first square of the difference between the input signals, and wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the sum of the input signals.

11. The signal multiplier of claim 10, wherein the multiplier sum circuit is further configured to produce a sum of the first square of the difference between the input signals and the second square of the difference between the input signals.

12. A signal multiplier comprising:
a passive charge domain sum circuit configured to receive a plurality of input signals and to produce a sum of the input signals, the passive charge domain sum circuit including a first capacitor and a second capacitor in parallel with the first capacitor, the first capacitor configured to receive a first one of the input signals via a first switch, the second capacitor configured to receive a second one of the input signals via a second switch, the first capacitor operatively coupled to an output via a third switch, and the second capacitor operatively coupled to the output;
a passive charge domain difference circuit configured to receive the input signals and to produce a difference between the input signals, the passive charge domain difference circuit including a third capacitor and a fourth capacitor in parallel with the third capacitor, the third capacitor configured to receive the first one of the input signals via a fourth switch, the fourth capacitor configured to receive the second one of the input signals via a fifth switch, the third capacitor operatively coupled to an output via a sixth switch, and the second capacitor operatively coupled to the output; and
a signal squaring circuit configured to receive the sum of the input signals and the difference between the input signals, and to produce a square of the sum of the input signals and a square of the difference of the input signals.

13. The signal multiplier of claim 12, wherein the first switch, the second switch, the fourth switch, and the fifth switch are closed by a first control pulse, wherein the third switch and the sixth switch are closed by a second control pulse, and wherein the second control pulse occurs subsequent to the first control pulse.

14. The signal multiplier of claim 12, wherein the signal squaring circuit includes a first differential pair of transistors operatively coupled to a positive voltage source terminal, a negative voltage source terminal, and a terminal configured to provide the sum of the input signals, and a second differential pair of transistors operatively coupled to the positive voltage source terminal, the negative voltage source terminal, and terminal configured to provide the difference between the input signals.

15. The signal multiplier of claim 14, further comprising a capacitor operatively coupled to a control terminal of at least one of the transistors.

16. The signal multiplier of claim 12, wherein the input signals are complex signals with real and imaginary components.

17. A signal multiplier comprising:
a sum circuit configured to receive a plurality of input signals and to produce a sum of the input signals in a passive charge domain;
a difference circuit configured to receive the input signals and to produce a difference between the input signals in a passive charge domain; and
a signal squaring circuit configured to receive the sum of the input signals and the difference between the input signals, and to produce a square of the sum of the input signals and a square of the difference of the input signals.

18. The signal multiplier of claim 17, wherein the input signals are complex signals with real and imaginary components, and wherein one or both of the sum circuit and the difference circuit are configured to operate in the passive charge domain where the sum circuit and/or the difference circuit consumes energy but does not produce energy.

19. The signal multiplier of claim 18, wherein the signal squaring circuit is a first signal squaring circuit configured to produce a first square of the sum of the input signals and a first square of the difference between the input signals, wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the difference between the input signals, and wherein the multiplier sum circuit is further configured to produce a sum of the first square of the difference between the input signals and the second square of the sum of the input signals.

20. The signal multiplier of claim 18, wherein the signal squaring circuit is a first signal squaring circuit configured to produce a first square of the sum of the input signals and a first square of the difference between the input signals, wherein the signal multiplier further comprises a second signal squaring circuit configured to produce a second square of the sum of the input signals and a second square of the difference between the input signals, and a multiplier sum circuit configured to produce a sum of the first square of the sum of the input signals and the second square of the sum of the input signals, and wherein the multiplier sum circuit is further configured to produce a sum of the first square of the difference between the input signals and the second square of the difference between the input signals.
